(19) United States
(12) Patent Application Publication
(10) Pub. No.: US 2015/0316103 A1
(43) Pub. Date: Nov. 5, 2015

(54) ROLLING BEARING

(71) Applicant: JTEKT CORPORATION, Osaka-shi, Osaka (JP)

(72) Inventors: Shigeru INOUE, Yokohama-shi (JP); Yutaka KOMA, Hachioji-shi (JP); Masao TAKIMOTO, Kashiwara-shi (JP); Yuya ONO, Yokohama-shi (JP)

(21) Appl. No.: 14/651,919

(22) PCT Filed: Nov. 19, 2013
(86) PCT No.: PCT/JP2013/081089

§ 371 Date: Jun. 12, 2015

(30) Foreign Application Priority Data
Dec. 12, 2012 (JP) 2012-271208

(51) Int. Cl. F16C 33/78; B60B 27/00

(52) U.S. Cl. CPC F16C 33/7896; B60B 27/001; B60B 27/0073

(57) ABSTRACT

A rolling bearing includes an inner ring having an inner raceway face, an outer ring having an outer raceway face opposed to the inner raceway face, rolling elements rolling along the inner and outer raceway faces, in an interior of the bearing between the inner and outer rings, a first seal member interposed between an outer peripheral face of the inner ring and an inner peripheral face of the outer ring, and sealing the interior of the bearing, and a second seal member arranged in parallel with the first seal member, outside in an axial direction. The first and second seal members are disposed at a side closer to the interior of the bearing than an end face of the inner ring and an end face of the outer ring in the axial direction.

### TECHNICAL FIELD

The present invention relates to a rolling bearing.

### BACKGROUND ART

As a conventional bearing device for a wheel, there has been a bearing device including: a hub shaft which is rotatable around a center axis; a rolling bearing for rotatably supporting the hub shaft with respect to a vehicle body; a seal mechanism at a wheel side for sealing an interior of the rolling bearing at the wheel side; and a seal mechanism at a vehicle body side for sealing the interior of the rolling bearing at the vehicle body side (refer to Patent Document 1, for example).

In the bearing device described in Patent Document 1, the hub shaft which is connected to a drive shaft has a wheel mounting flange for mounting the wheel, on an outer peripheral face thereof. The rolling bearing includes an inner ring, an outer ring and rolling elements in double rows, and is disposed on an outer circumference of the hub shaft. The seal mechanism at the wheel side is interposed between an outer peripheral face of the inner ring and an inner peripheral face of the outer ring, and provided in a manner opposed to the wheel mounting flange in an axial direction. The seal mechanism at the vehicle body side includes two seal members, which are arranged in parallel, on a rotation axis. In the seal mechanism at the vehicle body side, one of the seal members is interposed between the outer peripheral face of the inner ring and the inner peripheral face of the outer ring. The other seal member has a core bar which is press-fitted to the outer peripheral face of the outer ring to be fixed to the outer ring, and an elastic member which is attached to the core bar. A lip part of the elastic member is in contact with an outer peripheral face of the hub shaft.

In the above described structure, when a torque is transmitted from an engine of the vehicle to the hub shaft by way of the drive shaft, the wheel is rotated together with the hub shaft and the inner ring. While the vehicle is running, intrusion of muddy water or the like into the rolling bearing is blocked by the seal mechanism at the wheel side and the seal mechanism at the vehicle body side.

### PRIOR ART DOCUMENT

### Patent Document

Patent Document 1: JP-A-2010-19340

### SUMMARY OF THE INVENTION

### Problems that the Invention is to Solve

However, in the bearing device for the wheel disclosed in Patent Document 1, the other seal member in the seal mechanism at the vehicle body side is arranged more close to the vehicle body than the inner ring and the outer ring. Therefore, a length in the axial direction of the entire device including this other seal member is inevitably increased.

In view of the above, it is an object of the invention to provide a rolling bearing capable of restraining an increase of an axial length, while keeping high sealing performance, and a bearing device for a wheel provided with this rolling bearing.

### Means for Solving the Problems

In order to attain the above described object, there is provided, according to the invention, a rolling bearing as described in items (1) to (4), and a bearing device for a wheel provided with this rolling bearing.

(1) A rolling bearing comprising: an inner ring having an inner raceway face; an outer ring arranged on an outer circumference of the inner ring, and having an outer raceway face opposed to the inner raceway face; a plurality of rolling elements which are configured to roll along the inner raceway face and the outer raceway face, in an interior of the bearing between the inner ring and the outer ring; a first seal member which is interposed between an outer peripheral face of the inner ring and an inner peripheral face of the outer ring, and which is configured to seal the interior of the bearing; and a second seal member which is arranged in parallel with the first seal member, outside in an axial direction, wherein the first seal member and the second seal member are disposed at a side closer to the interior of the bearing than an end face of the inner ring and an end face of the outer ring in the axial direction.

(2) The rolling bearing as described above in (1), wherein the second seal member includes a base member which is attached to the outer peripheral face of the inner ring, and an elastic member which is joined to the base member, and a contact part of the elastic member which is in elastic contact with the inner peripheral face of the outer ring is arranged on an outer circumference of the base member.

(3) The rolling bearing as described above in (1) or (2), wherein an outer diameter of the inner ring at an inner peripheral side of the second seal member is smaller than the outer diameter of the inner ring at an inner peripheral side of the first seal member.

(4) The rolling bearing as described above in any one of (1) to (3), wherein an inner diameter of the outer ring at an outer peripheral side of the second seal member is larger than the outer diameter of the outer ring at an outer peripheral side of the first seal member.

### Advantage of the Invention

According to the invention, it is possible to reduce an axial length of the rolling bearing.

### BRIEF DESCRIPTION OF THE DRAWINGS

FIG. 1 is a sectional view for explaining an entire structure of a bearing device for a wheel which is provided with a rolling bearing in a first embodiment according to the invention.

FIG. 2 is a sectional view for explaining an essential part of the rolling bearing in the first embodiment according to the invention.

FIG. 3 is a sectional view for explaining an essential part of a rolling bearing in a second embodiment according to the invention.

FIG. 4 is a sectional view for explaining the essential part of the rolling bearing in the second embodiment according to the invention, as a modification.

FIG. 5 is a sectional view for explaining an essential part of a rolling bearing in a third embodiment according to the invention.

FIG. 6 is a sectional view for explaining the essential part of the rolling bearing in the third embodiment according to the invention, as a modification.

### MODE FOR CARRYING OUT THE INVENTION

### First embodiment

### Entire Structure of the Bearing Device for the Wheel

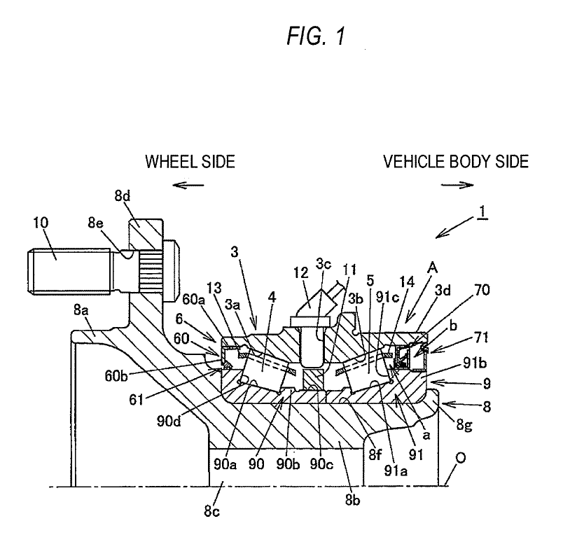

FIG. 1 shows an entire structure of the bearing device for the wheel. As shown in FIG. 1, a bearing device 1 for a wheel is, for example, a bearing device for a driving wheel, and includes an inner member 2 which is rotatable around a center axis O, an outer member 3 which is disposed on an outer circumference of the inner member 2, rolling elements 4, 5 in double rows which are interposed between the outer member 3 and the inner member 2, and a seal mechanism 6 at a wheel side and a seal mechanism 7 at a vehicle body side for sealing an interior of a rolling bearing (a taper roller bearing) at the wheel side (an outer side of the vehicle) and at the vehicle body side (an inner side of the vehicle) of the rolling elements 4, 5 in double rows. This bearing device 1 for the wheel is disposed between the vehicle body (not shown) and the wheel (not shown). In this embodiment, the seal mechanism 7 at the vehicle body side includes a first seal member 70 and a second seal member 71. The bearing device 1 for the wheel supports a hub ring 8 with respect to the vehicle body so as to rotate by way of the rolling bearing A. The rolling bearing A is used as a unit component having an inner ring 9, the outer member 3, the rolling elements 4, 5, and the seal mechanisms 6, 7.

### (Structure of the Inner Member 2)

The inner member 2 includes the hub ring 8 and the inner ring 9, and rotatably arranged on the center axis O.

The hub ring 8 has two large and small body parts 8a, 8b (a large diameter body part 8a, a small diameter body part 8b) having respective outer diameters which are different from each other. The hub ring 8 is coupled to a drive shaft (not shown) by means of a constant velocity universal joint (not shown) so as to transmit the torque. An entirety of the hub ring 8 is formed of, for example, medium carbon steel into a molded body in a cylindrical shape. The hub ring 8 is provided with a through hole 8c which is open to opposite directions along the center axis O. A serration (not shown) for coupling a stem (not shown) of the constant velocity universal joint is formed in an inner peripheral part of the through hole 8c.

The large diameter body part 8a is arranged at the wheel side of the hub ring 8 (the left side in FIG. 1). A wheel mounting flange 8d in an annular shape for mounting a wheel (not shown) is integrally formed on an outer peripheral face of the large diameter body part 8a so as to protrude at the wheel side. The wheel mounting flange 8d is provided with a plurality of bolt inserting holes 8e (only one of them is shown) which are arranged in parallel in a circumferential direction, and hub bolts 10 can be inserted in.

The small diameter body part 8b has a recess 8f in an annular shape which is open in a radial direction, on an outer peripheral face thereof, and is disposed at the vehicle body side of the hub ring 8 (the right side in FIG. 1). The small diameter body part 8b is passed through the inner ring 9. A vehicle body side insertion end of the small diameter body part 8b, out of both insertion ends (a vehicle body side insertion end at the right side and a wheel side insertion end at the left side, in FIG. 1), is caulked over a vehicle body side end face of the inner ring 9 (a second inner ring member 91) thereby to form a caulked part 8g. In this manner, the inner ring 9 is attached to the recess 8f.

On the other hand, the inner ring 9 includes a first inner ring member 90 and the second inner ring member 91. The first inner ring member 90 and the second inner ring member 91 are arranged in parallel with each other in a direction of the center axis O. The first inner ring member 90 and the second inner ring member 91 are molded products in a substantially cylindrical shape formed of, for example, carburizing steel, and attached inside the recess 8f of the hub ring 8.

The first inner ring member 90 has a first inner raceway face 90a on which the rolling elements 4 in a wheel side row out of the rolling elements 4, 5 in double rows are rolled, and a ring mounting face 90c which is arranged in parallel with the first inner raceway face 90a interposing a partition part 90b. The first inner ring member 90 is disposed at the wheel side of the inner ring 9 along the center axis O.

The first inner raceway face 90a is provided on a bottom of a concave groove 90d in an annular shape which is formed in an outer peripheral part of the first inner ring member 90. An outer diameter of the first inner raceway face 90a is so set as to be gradually increased in a direction from the vehicle body side to the wheel side.

The partition part 90b is arranged in a substantially center part in an axial direction of the first inner ring member 90. Moreover, the partition part 90b is formed as a cylindrical body part in a substantially uniform cylindrical shape which has an outer diameter larger than a smallest outer diameter of the first inner raceway face 90a and an outer diameter of the ring mounting face 90c.

The ring mounting face 90c is arranged at the vehicle body side of the first inner ring member 90. A pulsar ring 11 as a rotation velocity detecting ring, which is provided with concaves and convexes (both are not shown) alternately along a circumferential direction, is attached to the ring mounting face 90c.

The second inner ring member 91 has a second inner raceway face 91a which is arranged in parallel with the first inner raceway face 90a interposing the ring mounting face 90c, and on which the rolling elements 5 in a vehicle body side row out of the rolling elements 4, 5 in double rows are rolled. The second inner ring member 91 is arranged adjacent to the first inner ring member 90 at the vehicle body side thereof in the axial direction, along the center axis O.

The second inner ring member 91 is provided with an inner ring side extended part 91b which is formed by extending its vehicle body side end, for containing a second seal member 71 of the seal mechanism 7 at the vehicle body side. An outer diameter Do₁ of the inner ring side extended part 91b is set to be smaller than an outer diameter Do₂ of the second inner ring member 91 at an inner peripheral side of the first seal member 70 (an inner diameter of the first seal member 70).

The second inner raceway face 91a is arranged in a substantially center part of the second inner ring member 91 in the axial direction. Moreover, the second inner raceway face 91a is provided on a bottom of a concave groove 91c in an annular shape which is formed in an outer peripheral part of the second inner ring member 91. An outer diameter of the second inner raceway face 91a is so set as to be gradually increased in a direction from the wheel side to the vehicle body side.

### (Structure of the Outer Member 3)

The outer member 3 has outer raceway faces 3a, 3b on which the rolling elements 4, 5 in double rows are respectively rolled, and is mounted to the vehicle body side by means of a knuckle (not shown) as a component of a suspension device (not shown). Moreover, the outer member 3 is a molded product in a substantially cylindrical shape which is formed of, for example, medium carbon steel, and provided with a sensor mounting hole 3c for mounting an ABS (Anti-Lock Brake System) sensor 12. The outer member 3 functions as an outer ring of the bearing device 1 for the wheel (the rolling bearing A).

The outer member 3 is provided with an outer ring side extended part 3d which is formed by extending its vehicle body side end, for containing the second seal member 71 of the seal mechanism 7 at the vehicle body side. An inner peripheral face of the outer ring side extended part 3d is arranged at a position opposed to an outer peripheral face of the inner ring side extended part 91b. An outer diameter Di₁ of the outer ring side extended part 3d is set to be larger than an inner diameter Di₂ of the outer member 3 at an outer peripheral side of the first seal member 70 (an outer diameter of the first seal member 70).

As the results, there is formed an annular space b between the inner peripheral face of the outer ring side extended part 3b and the outer peripheral face of the inner ring side extended part 91b. The annular space b has a larger diameter than an annular space a which is formed between the inner peripheral face of the outer member 3 and the outer peripheral face of the second inner ring member 91 at the outer peripheral side and at the inner peripheral side of the first seal member 70.

### (Structure of the Rolling Elements 4, 5 in Double Rows)

The rolling elements 4, 5 in double rows are disposed so as to roll inside the bearing between the inner ring 9 and the outer member 3. The rolling elements 4 in a wheel side row are taper rollers, and are disposed in a manner interposed between the first inner raceway face 90a of the first inner ring member 90 and the outer raceway face 3a of the outer member 3 which are opposed to each other. At the same time, the rolling elements 4 are held by a roller cage 13 so as to roll. The rolling elements 5 in a vehicle body side row are taper rollers in the same manner as the rolling elements 4, and are disposed in a manner interposed between the second inner raceway face 91a of the second inner ring member 91 and the outer raceway face 3b of the outer member 3 which are opposed to each other. At the same time, the rolling elements 5 are held by a roller cage 14 so as to roll.

### (Structure of the Seal Mechanism 6 at the Wheel Side)

The seal mechanism 6 at the wheel side has a core bar 60 and an elastic member 61. The seal mechanism 6 is disposed in a manner interposed between the outer peripheral face of the first inner ring member 90 and the inner peripheral face of the outer member 3, at the wheel side of the rolling elements 4 out of the rolling elements 4, 5 in double rows. Then, the seal mechanism 6 at the wheel side seals the interior of the rolling bearing A at the wheel side.

The core bar 60 has a cylindrical part 60a and an inner flange 60b, and is attached to the inner peripheral face of the outer member 3, by press-fitting the cylindrical part 60a into the outer member 3 from the wheel side. The core bar 60 is a cylindrical member which is formed of, for example, austenitic stainless steel sheet or the like.

The elastic member 61 is bonded to the inner flange 60b of the core bar 60 by vulcanizing, for example. The elastic member 61 is an annular member which is in sliding contact with the outer peripheral face of the first inner ring member 90, and formed of, for example, elastically deformable synthetic rubber such as NBR (nitrile-butadiene rubber).

### (Structure of the Seal Mechanism 7 at the Vehicle Body Side)

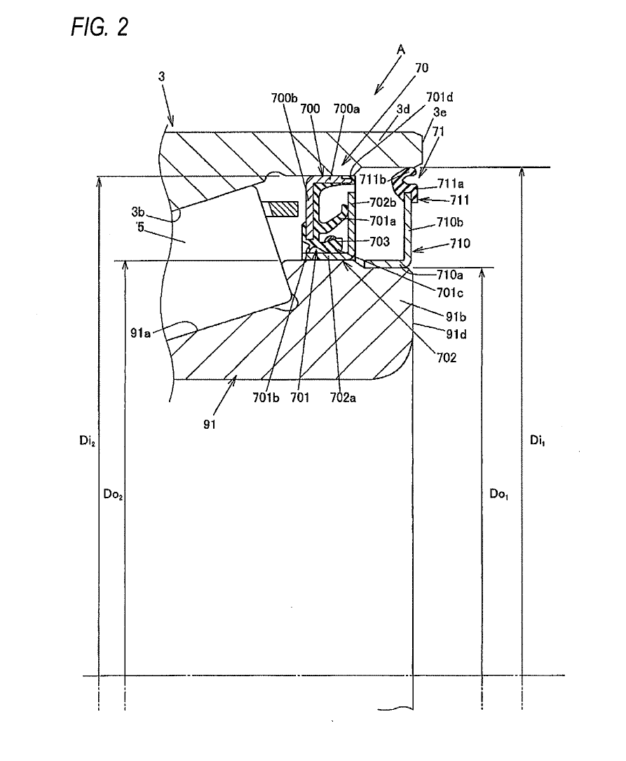

FIG. 2 shows an essential part of the rolling bearing. As shown in FIG. 2, the seal mechanism 7 at the vehicle body side includes the first seal member 70 and the second seal member 71, and is disposed at the vehicle body side of the rolling elements 5 out of the rolling elements 4, 5 in double rows. The first seal member 70 and the second seal member 71 are so constructed as to respectively exert sealing functions, independently. The second seal member 71 is arranged in parallel with the first seal member 70 at an outer side in the axial direction (at the vehicle body side) of the first seal member 70. The seal mechanism 7 at the vehicle body side seals the interior of the rolling bearing A (the interior of the bearing) at the vehicle body side. In this manner, it is possible to enhance the sealing performance (muddy water resistance) in this embodiment, as compared with a case where the seal mechanism 7 at the vehicle body side includes a single seal member.

The first seal member 70 has a core bar 700, an elastic member 701, and a slinger 702, and is disposed at the vehicle body side of the rolling elements 5 in a manner interposed between the outer peripheral face of the second inner ring member 91 and the inner peripheral face of the outer member 3.

The core bar 700 has a cylindrical part 700a and an inner flange 700b, and is attached to the outer member 3, by press-fitting the cylindrical part 700a into the outer member 3 from the vehicle body side. The core bar 700 is a cylindrical member which is formed of, for example, austenitic stainless steel sheet or the like.

The elastic member 701 has a side lip 701a, a grease lip 701b and a dust lip 701c. The elastic member 701 is joined (bonded) to the core bar 700 by vulcanizing, for example, and pressed against an outer peripheral face of a slinger 702 by means of a garter spring 703. The elastic member 701 is an annular member formed of, for example, synthetic rubber such as NBR (nitrile-butadiene rubber). The side lip 701a is in sliding contact with a flange 702b of the slinger 702, the grease lip 701b is in sliding contact with a cylindrical part 702a of the slinger 702 at the wheel side, and the dust lip 701c is in sliding contact with the cylindrical part 702a of the slinger 702 at the vehicle body side.

The elastic member 701 is provided with a folded-back part 701d which is interposed between an opening end of the cylindrical part 700a of the core bar 700 and the inner peripheral face of the outer member 3, and protruded outward in a radial direction. In this manner, sealing performance between the opening end of the cylindrical part 700a and the inner peripheral face of the outer member 3 is enhanced.

The slinger 702 has the cylindrical part 702a and the flange 702b, and the cylindrical part 702a is attached to the outer peripheral face of the second inner ring member 91. The cylindrical part 702a of the slinger 702 is press-fitted to the outer peripheral face of the second inner ring member 91 which has been fixed to the hub ring 8 in advance. The slinger 702 is a cylindrical member which is formed of, for example, austenitic stainless steel sheet or the like. The cylindrical part 702a is opposed to the cylindrical part 700a of the core bar 700, and the flange part 702b is opposed to the inner flange 700b of the core bar 700, respectively interposing the elastic member 701.

The second seal member 71 has a core bar (a base member) 710 and an elastic member 711, and is disposed at the vehicle body side of the first seal member 70 in a manner interposed between the outer peripheral face of the inner ring side extended part 91b and the inner peripheral face of the outer ring side extended part 3d. The core bar 710 is formed of, for example, austenitic stainless steel sheet or the like. The elastic member 711 is formed of, for example, synthetic rubber such as NBR (nitrile-butadiene rubber).

The core bar 710 integrally has a cylindrical part 710a which is press-fitted into the inner ring side extended part 91b, and an annular flange 710b which is protruded outward from a vehicle body side end of the cylindrical part 710a. The elastic member 711 integrally has a base part 711a which is joined (bonded) to a distal end (a distal end outside in a radial direction) of the flange 710b by vulcanizing, for example, and a lip part (a contact part) 711b which is in elastic contact with the inner peripheral face of the outer ring side extended part 3d. The lip part 711b is disposed on an outer periphery of the core bar 710.

The seal mechanism at the vehicle body side is assembled as follows; The first inner ring member 90 and the second inner ring member 91 composing the inner ring 9 are fitted into the recess 8f of the hub ring 8, and the vehicle body side end of the small diameter body part 8b of the hub ring 8 is caulked thereby to form the caulked part 8g. Thereafter, the first seal member 70 is press-fitted into between the outer peripheral face of the second inner ring member 91 and the inner peripheral face of the outer member 3, and further, the second seal member 71 is press-fitted into between the inner ring side extended part 91b of the second inner ring member 91 and the outer ring side extended part 3d of the outer member 3. On this occasion, the second seal member 71 is arranged more inward of the bearing (a side close to the rolling elements 5) than the end face 91d in the axial direction of the second inner ring member 91 and the end face 3e in the axial direction of the outer member 3 at the vehicle body side. Specifically, in this embodiment, the first seal member 70 and the second seal member 71 are arranged more inward of the bearing than the end face 91d in the axial direction of the second inner ring member 91 and the end face 3e in the axial direction of the outer member 3 at the vehicle body side.

### (Operation of the Bearing Device 1 for the Wheel)

Operation of the bearing device 1 for the wheel in this embodiment is performed in the same manner as operation of the conventional bearing device for the wheel. Specifically, when a torque is transmitted from the engine of the vehicle to the hub ring 8 by way of the drive shaft, the constant velocity universal joint, and so on, the hub ring 8 is rotated together with the inner ring 9. Because the wheel is mounted to the hub ring 8, the torque from the engine is transmitted to the wheel, and the wheel is rotated together with the hub ring 8. In this case, intrusion of muddy water or the like into the rolling bearing A, while the vehicle is running, is blocked by the seal mechanism 6 at the wheel side and the seal mechanism 7 at the vehicle body side. Particularly, because the first seal member 70 and the second seal member 71 are arranged in parallel in a direction of the center axis O, in the seal mechanism 7 at the vehicle body side, intrusion of muddy water or the like into the rolling bearing A is efficiently blocked, as compared with a case where a single seal mechanism is provided.

### Advantages of the First Embodiment

According to the first embodiment as described above, the following advantages can be obtained.

(1) The first seal member 70 and the second seal member 71 are disposed between the outer peripheral face of the inner ring 9 (the second inner ring member 91) and the inner peripheral face of the outer member 3. Therefore, it is possible to reduce an axial length of the rolling bearing A and the bearing device 1 for the wheel, as compared with a case where only the first seal member 70 is disposed between the outer peripheral face of the inner ring 9 and the inner peripheral face of the outer member 3, and the other seal member is separately disposed at the vehicle body side thereof.

(2) The first seal member 70 and the second seal member 71 respectively exert the sealing functions, independently. Because the elastic member 711 of the second seal member 71 is not provided with a lip part which comes into contact with the slinger 702 of the first seal member 70, it is possible to make the second seal member 71 loaded in a good shape. Specifically, provided that the lip part 711b of the elastic member 711 of the second seal member 71 is in contact with the slinger 702, when a plurality of the second seal members 71 are stacked in an axial direction to be transported or stored, the lip part is strongly pressed against the core bar 710 of the other second seal member 71 adjacent thereto. In case where this situation lasts for a long period, there is such anxiety that the lip part is deformed and the sealing performance is deteriorated. However, there is no such anxiety in this embodiment, because the lip part 711b is so formed as to come into contact with the inner peripheral face of the outer member 3.

(3) In a state assembled to the bearing device 1 for the wheel, the lowermost part of the second seal member 71 in the vertical direction is the lip part 711b. Therefore, when muddy water or the like enters inside of the second seal member 71 (toward the first seal member 70), the muddy water or the like is easily discharged, as compared with a case where the cylindrical part 710a of the core bar 710 is press-fitted to the inner peripheral face of the outer ring side extended part 3d and the lip part 711b of the elastic member 711 comes into contact with the outer peripheral face of the inner ring side extended part 91b. Specifically, in case where the core bar 710 is in the lowermost part of the second seal member 71 in the vertical direction, the muddy water or the like which has entered inside the core bar 710 remains as it is. However, in this embodiment, the lip part 711b is in the lowermost part of the second seal member 71 in the vertical direction, and therefore, the muddy water or the like is likely to be discharged from a gap between the lip part 711b and the inner peripheral face of the outer ring side extended part 3d.

(4) The annular space b which is formed between the inner peripheral face of the outer ring side extended part 3d and the outer peripheral face of the inner ring side extended part 91b of the second inner ring 91 has a larger size in a radial direction than the annular space a which is formed between the inner peripheral face of the outer member 3 and the outer peripheral face of the second inner ring member 91 and in which the first seal member 70 is contained. Therefore, when the first seal member 70 is assembled, there is no necessity of press-fitting the first seal member 70 in a range of the annular space b. Specifically, it is possible to reduce a press-fitting distance (an axial distance of pushing in the first seal member 70, while receiving a repulsive force by press-fitting) in assembling the first seal member 70, and hence, workability in assembling can be enhanced. It is to be noted that in this embodiment, an outer diameter Do₁ of the second inner ring member 91 in the inner ring side extended part 91b is set to be smaller than an outer diameter Do₂ of the second inner ring member 91 in the annular space a in which the first seal member 70 is contained (Do₁<Do₂), and an inner diameter Di₁ of the outer member 3 in the outer ring extended part 3d is larger than an outer diameter Di₂ of the outer member 3 in the annular space a in which the first seal member 70 is contained (Di₁>Di₂). However, in case where Do₁<Do₂, Di₁ may be equal to Di₂. Moreover, in case where Di₁>Di₂, Do₁ may be equal to Do₂. In short, provided that relation Do₁<Do₂ or relation Di₁>Di₂ is satisfied, Di₁ may be equal to Di₂ or Do₁ may be equal to Do₂.

(5) The second seal member 71 is disposed between the outer peripheral face of the inner ring 9 and the inner peripheral face of the outer member 3. Therefore, the sealing performance is excellent, as compared with a case where the lip part of the seal member which is disposed outside of the inner ring and the outer ring is in contact with a caulked part (a part corresponding to the caulked part 8g in this embodiment) of the hub ring (a hub shaft), as disclosed in Patent Document 1. Specifically, an outer peripheral face of the caulked part is not necessarily parallel to the center axis O, but curved or inclined with respect to the axial direction (for example, accuracy of roundness or surface roughness is not constant), in some cases. In such cases, the sealing performance of the seal member is deteriorated. However, according to this embodiment, it is possible to enhance the sealing performance, because the lip part 711b of the second seal member 71 comes into contact with the inner peripheral face of the outer member 3.

### Second Embodiment

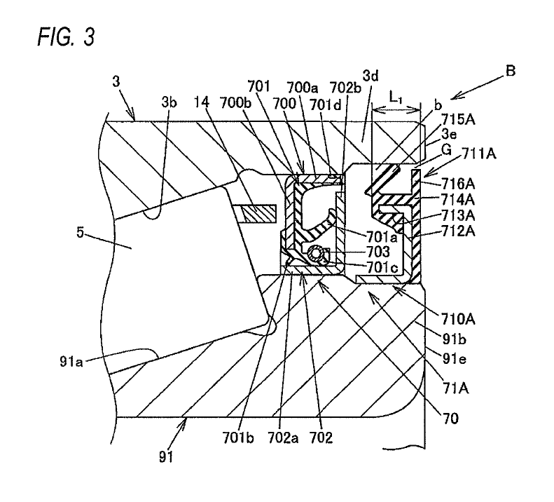

Then, a rolling bearing in a second embodiment according to the invention will be described referring to FIG. 3. FIG. 3 shows an essential part of the rolling bearing. In FIG. 3, the members having the same or similar functions as those in FIGS. 1 and 2 will be denoted with the same reference numerals, and detailed descriptions of them will be omitted.

As shown in FIG. 3, a rolling bearing B in the second embodiment according to the invention is characterized in that a seal side extended part 716A of an elastic member 711A in a second seal member 71A is protruded outward of a core bar 712A, and a lip part 715A is provided inward of the seal side extended part 716A (at an inward side of the bearing).

The second seal member 71A has an elastic member 711A and a core bar 710A having a flange 712A, in the same manner as in the first embodiment. The second seal member 71A is attached to the outer peripheral face of the inner ring side extended part 91b, by press-fitting the core bar 710A into the inner ring side extended part 91b. For enhancing the sealing performance, a gap between an inner peripheral face of the core bar 710A and the outer peripheral face of the inner ring side extended part 91b may be wrapped with rubber or the like.

An outer peripheral edge of the flange 712A is folded back toward the rolling elements 5 thereby to form a concave groove 713A in annular shape which is open toward the first seal member 70. As the results, it is possible to dispose a base end of the lip part 715A in a deep position in the annular space b (at a side close to the rolling elements 5). In this manner, a sealing length of the elastic member 711A (a length of the lip part 715A) can be set to be larger, and sliding resistance with respect to the outer member 3 is reduced.

The elastic member 711A has a base part 714A, the lip part 715A, and the seal side extended part 716A, and is joined (bonded) to an outer groove wall and a groove bottom of the concave groove 713A by vulcanizing, for example. The elastic member 711A is an annular member which is in sliding contact with the inner peripheral face of the outer ring side extended part 3d, and formed of, for example, elastically deformable synthetic rubber such as NBR (nitrile-butadiene rubber).

The base part 714A functions as a part to be attached to the core bar 710A, and attached to the core bar 710A in such a manner that a part (an inner peripheral edge) of the base part 714A is opposed to an inner peripheral face of the core bar 710A. As the results, a gap formed between the outer peripheral face of the inner ring side extended part 91b and an inner peripheral face of the base part 714A is sealed, and hence, the sealing performance of the second seal member 71A is enhanced. An axial length L₁ of the base part 714A is set according to a height of the outer groove wall of the concave groove 713A. It is desirable that this axial length L₁ is more than a half of an axial length of the outer ring side extended part 3d.

The lip part 715A is in contact with the inner peripheral face of the outer ring side extended part 3d, and integrally provided on the base part 714A at the side close to the rolling elements 5 in the elastic member 711A. The lip part 715A is formed by being folded at an angle with respect to the center axis O to an opposite side to the first seal member 70.

The seal side extended part 716A is disposed at a position close to the inner peripheral face of the outer ring side extended part 3d, by extending the base part 714A at an opposite side to the lip part 715A (the vehicle body side) in the elastic member 711A. As the results, a radial length of a space G which is formed between the seal side extended part 716A and the inner peripheral face of the outer ring side extended part 3d is reduced, and hence, it is possible to obtain a labyrinth effect that muddy water or the like is unlikely to enter into the second seal member 71A.

### Advantages of the Second Embodiment

According to the second embodiment as described above, the following advantages can be obtained, in addition to the advantages as described above in items (1) to (5) in the first embodiment.

(6) Because the length of the lip part 715A of the elastic member 711A can be made longer than the lip part 711b in the first embodiment, the lip part 715A can be more elastically contacted with the inner peripheral face of the outer member 3. As the results, it is possible to enhance the sealing performance, and at the same time, to reduce the sliding resistance.

(7) Because the lip part 715A of the elastic member 711A can be disposed in the deep position in the annular space b, the muddy water or the like becomes unlikely to enter into the annular space b, owing to a so-called overhanging effect (such effect that a part of the outer ring side extended part 3d protruding toward the vehicle body than a contact part with respect to the lip part 715A prevents the muddy water or the like from splashing over the lip part 715A).

(8) Because the seal side extended part 716A is protruded outward than the core bar 712A, the muddy water or the like is prevented from splashing over the lip part 715A, and further, the muddy water or the like becomes unlikely to enter into the annular space b.

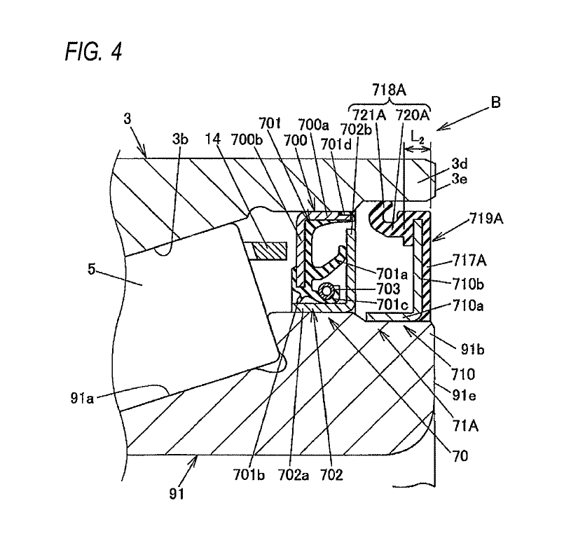

In this embodiment, a case where the elastic member 711A is attached to the outer groove wall and the groove bottom of the concave groove 713A in the second seal member 71A has been described. However, the invention is not limited to the case, but it is also possible to use the core bar 710 as shown in the first embodiment, and to attach an elastic member 719A having a base part 717A and a lip part 718A to this core bar 710, as shown in FIG. 4, as a modification. In FIG. 4, an axial length L₂ of the base part 717A is set to be smaller than an axial length L₁ of the base part 714A of the elastic member 711A (shown in FIG. 3) (L₁>L₂). The lip part 718A includes a protruding part 720A in a cylindrical shape protruding toward the first seal member 70, and a lip part 721A, as a contact part, which is formed by folding an end of the protruding part 720A at a side of the first seal member 70 to an opposite direction to the first seal member 70. The lip part 718A is integrally provided on the base part 717A.

According to this modification too, substantially the same advantages as described above in items (6) and (7) in the second embodiment can be obtained.

### Third Embodiment

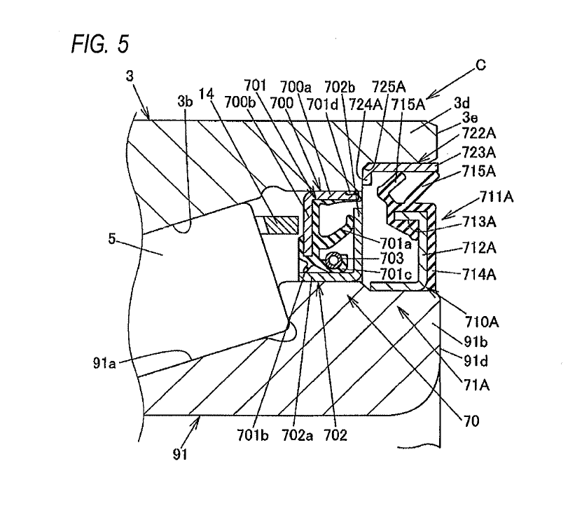

Then, a rolling bearing in a third embodiment according to the invention will be described referring to FIG. 5. FIG. 5 shows an essential part of the rolling bearing. In FIG. 5, the members having the same or similar functions as those in FIGS. 1 and 3 will be denoted with the same reference numerals, and detailed descriptions of them will be omitted.

As shown in FIG. 5, a rolling bearing C in the third embodiment according to the invention is characterized in that the elastic member 711A of the second seal member 71A has a plurality of (two in this embodiment) lip parts 715A, and a rust proof member 722A is interposed between the lip parts 715A and the outer ring side extended part 3d.

A plurality of the lip parts 715A are in sliding contact with an inner peripheral face of the rust proof member 722A, and arranged in parallel in an axial direction of the elastic member 711A. It is to be noted that the lip part at the vehicle body side, out of a plurality of the lip parts 715A, may be in non-contact state where the lip part is not in contact with the inner peripheral face of the rust proof member 722A, provided that the lip part is positioned close to the inner peripheral face of the rust proof member 722A thereby to obtain muddy water resistance (the labyrinth effect).

The rust proof member 722A is formed of, for example, austenitic stainless steel sheet, and has a cylindrical part 723A and an inner flange 724A. The rust proof member 722A is attached to the inner peripheral face of the outer ring side extended part 3d, by press-fitting the cylindrical part 723A into the outer ring side extended part 3d. The outer member 3 is provided with a stepped face 725A against which the inner flange 724A is butted.

### Advantages of the Third Embodiment

According to the third embodiment as described above, the following advantages can be obtained, in addition to the advantages as described above in items (1) to (5) in the first embodiment.

(9) Because the elastic member 711A has a plurality of (two in this embodiment) the lip parts 715A, the muddy water resistance can be more effectively enhanced.

(10) The part along which a plurality of the lip parts 715A slide (the rust proof member 722A) becomes unlikely to rust, and therefore, it is possible to obtain excellent sliding performance for a long period.

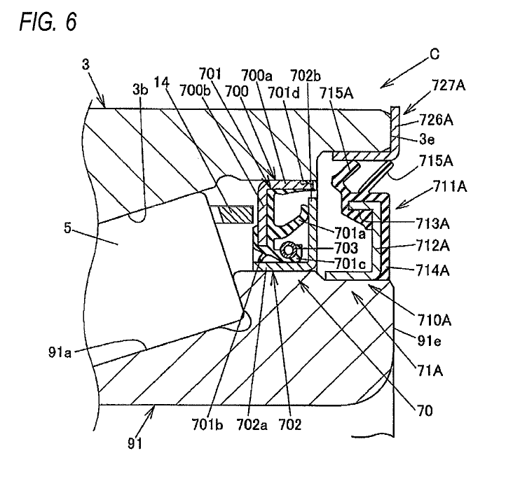

In this embodiment, a case where the rust proof member 722A has the inner flange 724A has been described. However, the invention is not limited to the case, but the rust proof member may be formed as a rust proof member 727A having a flange 726A which is in contact with an opening end face of the outer ring side extended part 3d, as shown in FIG. 6, as a modification.

The rolling bearing according to the invention and the bearing device for the wheel provided with this rolling bearing has been heretofore described, referring to the above described embodiments. However, the invention is not limited to the above described embodiments, but the invention can be carried out in various ways within a range not deviating from the gist of the invention. For example, the following modifications can be also made.

(1) In the above described embodiments, a case where the rolling bearing is a taper roller bearing in which the rolling elements 4, 5 are taper rollers has been described. However, the invention is not limited to the case, but the bearing may be another roller bearing in which the rolling elements are cylindrical rollers, or another rolling bearing in a form of a ball bearing in which the rolling elements are balls.

(2) In the above described embodiments, a case where the invention is applied to the bearing device for the driving wheel has been described. However, the invention is not limited to the case, but it is also possible to apply the invention to the bearing device for a driven wheel, in the same manner as in the above described embodiment.

(3) In the above described embodiments, a structure in which the hub ring 8 can be rotated by way of the rolling bearing has been described. However, the invention is not limited to this structure. For example, it is also possible to provide such a structure that the outer ring can be rotated.

This invention is based on Japanese Patent Application filed on Dec. 12, 2012 (Patent Application No. 2012-271208), the contents of which are hereby incorporated by reference.

### INDUSTRIAL APPLICABILITY

According to the invention, it is possible to realize a rolling bearing capable of restraining an increase of an axial length, while keeping high sealing performance.

### DESCRIPTION OF THE REFERENCE NUMERALS

1 . . . Bearing device for wheel, 2 . . . Inner member, 3 . . . Outer member, 3a, 3b . . . Outer raceway face, 3c . . . Sensor mounting hole, 3d . . . Outer ring side extended part, 4, 5 . . . Rolling element, 6 . . . Seal mechanism at wheel side, 60 . . . Core bar, 60a . . . Cylindrical part, 60b . . . Inner flange, 61 . . . Seal member, 7 . . . Seal mechanism at vehicle body side, 70 . . . First seal member, 700 . . . Core bar, 700a . . . Cylindrical part, 700b . . . Inner flange, 701 . . . Elastic member, 701a . . . Side lip, 701b . . . Grease lip, 701c . . . Dust lip, 701d . . . Folded-back part, 702 . . . Slinger, 702a . . . Cylindrical part, 702b . . . Flange, 703 . . . Garter spring, 71 . . . Second seal member, 710 . . . Core bar, 710a . . . Cylindrical part, 710b . . . Flange, 711 . . . Elastic member, 711a . . . Base part, 711b . . . Lip part, 8 . . . Hub ring, 8a, 8b . . . Body part, 8c . . . Through hole, 8d . . . Wheel mounting flange, 8e . . . Bolt inserting hole, 8f . . . Recess, 8g . . . Caulked part, 9 . . . Inner ring, 90 . . . First inner ring member, 90a . . . First inner raceway face, 90b . . . Partition part, 90c . . . Ring mounting face, 90d . . . Concave groove, 91 . . . Second inner ring member, 91a . . . Second inner raceway face, 91b . . . Inner ring side extended part, 91c . . . Concave groove, 10 . . . Hub bolt, 11 . . . Pulsar ring, 12 . . . ABS sensor, 13, 14 . . . Cage, 71A . . . Second seal member, 710A . . . Slinger, 711A . . . Elastic member, 712A . . . Flange, 713A . . . Concave groove, 714A . . . Base part, 715A . . . Lip part, 716A . . . Seal side extended part, 717A . . . Base part, 718A . . . Lip part, 719A . . . Elastic member, 720A . . . Protruding part, 721A . . . Sliding part, 722A . . . Rust proof member, 723A . . . Cylindrical part, 724A . . . Inner flange, 725A . . . Stepped face, 726A . . . Flange, 727A . . . Rust proof member, a, b . . . Annular space, A, B, C . . . Rolling bearing, G . . . Gap, L₁, L₂ . . . Length in axial direction, O . . . Center axis

1. A rolling bearing comprising:
an inner ring having an inner raceway face,
an outer ring arranged on an outer circumference of the inner ring, and having an outer raceway face opposed to the inner raceway face;
a plurality of rolling elements which are configured to roll along the inner raceway face and the outer raceway face, in an interior of the bearing between the inner ring and the outer ring;
a first seal member which is interposed between an outer peripheral face of the inner ring and an inner peripheral face of the outer ring, and which is configured to seal the interior of the bearing; and
a second seal member which is arranged in parallel with the first seal member, outside in an axial direction,
wherein the first seal member and the second seal member are disposed at a side closer to the interior of the bearing than an end face of the inner ring and an end face of the outer ring in the axial direction.

2. The rolling bearing according to claim 1, wherein the second seal member includes a base member which is attached to the outer peripheral face of the inner ring, and an elastic member which is joined to the base member, and a contact part of the elastic member which is in elastic contact with the inner peripheral face of the outer ring is arranged on an outer circumference of the base member.

3. The rolling bearing according to claim 1, wherein an outer diameter of the inner ring at an inner peripheral side of the second seal member is smaller than the outer diameter of the inner ring at an inner peripheral side of the first seal member.

4. The rolling bearing according to claim 1, wherein an inner diameter of the outer ring at an outer peripheral side of the second seal member is larger than the outer diameter of the outer ring at an outer peripheral side of the first seal member.
